(19) United States
(12) Patent Application Publication
(10) Pub. No.: US 2003/0164004 A1
(43) Pub. Date: Sep. 4, 2003

(54) Method of manufacturing glass optical elements and method of determining glass composition of glass material

(75) Inventors: Shinichiro Hirota, Fuchu-shi (JP); Kouichi Sato, Nishitokyo-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: HOYA CORPORATION, Tokyo (JP)

(21) Appl. No.: 10/359,159

(22) Filed: Feb. 6, 2003

(30) Foreign Application Priority Data
Feb. 7, 2002 (JP) 2002-031244

(51) Int. Cl. C03B 5/00; C03B 11/08

(52) U.S. Cl. 65/29.16; 65/29.18

(57) ABSTRACT

Methods of manufacturing glass optical elements of desired surface precision and optical characteristics in which a softened glass material is press molded in a pressing mold of prescribed surface precision to transfer the molding surface of the pressing mold to the glass material. The method manufacturing glass optical elements of desired refractive index n₃, by means of a press molding process comprising press molding a softened glass material in a pressing mold and cooling a molded element with a predetermined cooling rate. The method comprises preparing a interim optical element by means of the press molding process from a glass material of a first glass composition, measuring a refractive index n₂ of the interim optical element, obtaining the difference between a reference refractive index n₁ of the first glass composition and the refractive index n₂, preparing a second glass composition having reference refractive index substantially of the value which is obtained by adding the difference to the refractive index n₃, and preparing an optical element by means of the press molding process from a glass material of the second glass composition, wherein the reference refractive index is the refractive index of glass composition processed with a standard condition.

### TECHNICAL FIELD

The present invention relates to methods of manufacturing high-precision glass optical elements. More specifically, the present invention relates to methods of manufacturing glass optical elements of desired surface precision and optical characteristics in which a softened glass material is press molded in a pressing mold of prescribed surface precision to transfer the molding surface of the pressing mold to the glass material.

### RELATED ART

In recent years, precision press molding techniques that do not require grinding and polishing after press molding have been advancing. Numerous lenses, particularly aspherical lenses, are now produced with these techniques.

In the manufacturing of glass optical elements, the control of optical characteristics is essential. This is determined by the specifications of the optical products in which the glass optical elements are employed. Usually, this control is achieved by specifying prescribed optical constants (typically denoted as the refractive index, n, and the Abbé number, ν) and the like along with acceptable ranges (tolerances). Refractive index n is denoted using measurement wavelengths such as the F line, d line, and c line. Of these, the refractive index n_{d} based on the d line is the most commonly employed indicator. The Abbé number, ν_{d}, is given by the following equation:

$${v}_{d} = \frac{{n}_{d} - 1}{{n}_{F} - {n}_{c}}$$

It is further known that optical glass having various constants over broad ranges can be manufactured by the selection of the glass composition.

As mentioned above, the refractive index of optical glass is measured with good precision at a variety of wavelengths from ultraviolet to infrared and is given as a value extending to the fifth decimal place. However, the refractive index measured at room temperature of glass of identical composition varies with the thermal history of the glass melt as it solidifies. For example, two glass materials of identical composition that are maintained at a temperature close to the glass transition point Tg will have refractive indexes measured at room temperature that differ with the rate at which the materials are cooled. Generally, the greater the cooling rate, the lower the refractive index, and the lower the cooling rate, the greater the refractive index. When manufacturing glass optical elements by press molding, as well, differences in cooling conditions following press molding result in differences in the refractive index of the optical elements. This appears as a problem in manufacture that the refractive index of produced optical elements shift from the desired refractive index range.

The use of an annealing step is known in the course of manufacturing glass optical elements. In an annealing step, a heat treatment is applied to the molded glass optical elements, chiefly with the objects of removing strain and adjusting the refractive index. An annealing step effectively yields glass optical elements having uniform and desired refractive indexes when adjusting the refractive index.

Japanese Unexamined Patent Publication (KOKAI) Showa No. 61-286236 discloses a method of gradually cooling glass optical elements comprising the steps of maintaining a press molded glass optical element for a prescribed period at a temperature greater than or equal to the strain point and less than or equal to the glass transition point, and a step of cooling at a rate at which the glass optical element assumes a desired refractive index. It is stated in this publication that the cooling step prevents refractive index variation between optical elements and within single optical elements due to nonuniform temperature, and permits adjustment of the refractive index within a certain range.

Japanese Unexamined Patent Publication (KOKAI) Heisei No. 7-53320 discloses a method of obtaining glass optical elements of desired refractive index from a glass material cut from a block or a glass material (blank) produced by shaping a glass melt to form resembling a lens. In this method, glass optical elements are manufactured by melting, heating, and press molding a glass material of predetermined composition, and a glass optical element is molded in said press molding step using a glass material having a refractive index of a value calculated by subtracting the amount of change in refractive index on the glass material that is produced during the press molding step from the value of the desired refractive index of the molded glass optical element.

Japanese Unexamined Patent Publication (KOKAI) Heisei No. 7-330354, discloses a method of controlling the cooling rate during cooling to yield a glass lens having a desired refractive index in view of changes in refractive index due to the cooling step following heating and molding.

Since the cooling rate in the cooling step is relatively high in press molding, the refractive index of the glass optical elements that are molded tends to become lower. Accordingly, the refractive index has been either adjusted to a desired level by employing an adequate annealing step, or it has been necessary to optically design the optical products based on a lowered refractive index.

The gradual cooling method disclosed in Japanese Unexamined Patent Publication (KOKAI) Showa No. 61-286236 makes it possible to obtain a glass optical element with a desired refractive index falling within a certain range. However, there are problems relating to production efficiency due to the equipment for annealing that is disclosed in the Publication and the fact that considerable time is required for the annealing step. There is a further production efficiency problem in that an annealing step becomes necessary following press molding even for glass optical elements with levels of strain that do not pose problems for optical design and for which elimination of strain is not necessarily required.

The method of Japanese Unexamined Patent Publication (KOKAI) Heisei No. 7-53320 presents the following problems.

In this method, it is necessary to actually measure the refractive index of the glass material prior to press molding to determine the amount of change in refractive index resulting from press molding. However, when the glass material prior to press molding has been quenched from glass melt, there is considerable strain and it is difficult to measure the refractive index, or there is considerable variation, precluding measurement.

Further, in Examples 1 and 2 of the above Publication, it is disclosed that even when glass materials of identical composition are employed in an identical press molding step, the refractive indexes of the glass elements obtained are not identical if the refractive index of the glass material employed differs. This means that the thermal history of the glass materials (blanks) is not eliminated in the press molding step, that is, that the thermal history of the glass materials affects the refractive index of the molded optical elements. Accordingly, based on this method, it is necessary for the interim glass material used to measure the refractive index change amount and the glass material used to manufacture the actual glass element to have identical thermal histories. That is, when the glass material employed to measure the refractive index change amount is quenched while in a liquid state, the glass material employed in the manufacturing of the glass element following composition adjustment must be quenched under identical conditions. If the quenching conditions are not strictly controlled, an optical element deviating from the desired refractive index is obtained.

Further, according to Examples 1 and 2 of the above Publication, even when glass materials of identical composition but having differing refractive indexes due to differing thermal histories are employed, the refractive index change amounts resulting from an identical pressing step differ. Thus, obtaining a glass element of prescribed refractive index requires differing composition adjustment in such case.

The method described in Japanese Unexamined Patent Publication (KOKAI) Heisei No. 7-330354 attempts to eliminate the discrepancy between the predicted and actual index drops of molded lenses. However, there is no indication whatsoever as to how to solve the drop problem itself.

The present invention, devised in light of the above-stated problems, has for its object to provide a alternative means of controlling the refractive index among adjustment of strain and adjustment of the refractive index—the original goals of annealing—and thereby increase the degree of freedom in manufacturing.

More specifically, the object of the present invention is to provide a method of conveniently manufacturing, with good precision and based on certain rules, glass optical elements having desired refractive indexes irrespective of the thermal history following melting of the glass material employed in the press molding step. A further object of the present invention is to provide a method of manufacturing glass optical elements that are readily controlled so as to determine constantly the refractive index of the glass optical element based on a fixed standard.

### SUMMARY OF THE INVENTION

The present invention relates to a method of manufacturing glass optical elements of desired refractive index n₃, by means of a press molding process comprising press molding a softened glass material in a pressing mold and cooling a molded element with a predetermined cooling rate, comprising:

preparing a interim optical element by means of the press molding process from a glass material of a first glass composition,

measuring a refractive index n₂ of the interim optical element,

obtaining the difference between a reference refractive index n₁ of the first glass composition and the refractive index n₂,

preparing a second glass composition having reference refractive index substantially of the value which is obtained by adding the difference to the refractive index n₃, and

preparing an optical element by means of the press molding process from a glass material of the second glass composition,

wherein the reference refractive index is the refractive index of glass composition processed with a standard condition.

This method is referred to hereinafter as “Manufacturing Method 1”.

It is preferred that Manufacturing Method 1 further comprises processing the glass material of the first glass composition with the standard condition for obtaining the reference refractive index n₁ in advance of the press molding process, and is more preferred that the second glass composition is prepared by adjusting the composition of the first glass composition

In the Manufacturing method 1, it is preferred that the glass material of the second glass composition has a reference Abbé number obtained by adding the value in the range from (ν₁−ν₂)×0.9 to (ν₁−ν₂)×1.1 to ν₃, when a reference Abbé number of the first glass composition is denoted as ν₁, an Abbé number of the interim optical element is denoted as ν₂, and an Abbé number of the desired optical element is denoted as ν₃, and the reference Abbé number is the Abbé number of glass composition processed with the standard conditions.

In the Manufacturing method 1, it is also preferred that the first glass composition has the reference refractive index n₁ , falling within a range of n₃±0.01 and a reference Abbé number falling within a range of ν₃±1.

In the Manufacturing method 1, it is further preferred that the desired refractive index n₃ of the glass optical element equals to the reference refractive index n₁, of the first glass composition.

In the Manufacturing method 1, it is still further preferred that the glass material of the first or the second glass composition is prepared by cooling the glass melt at a cooling rate of from 300° C. to 1,500° C./minutes at least over a range of from a softening point to a strain point minus 50° C.

In the Manufacturing method 1, it is further preferred that a refractive index of the glass material of the second glass composition is at least 500×10⁻⁵ lower than the reference refractive index of the same glass composition.

In the Manufacturing method 1, it is preferred that retardation by residual strain of the glass optical element along the optical axis thereof is equal to or less than 60 nm and the retardation by residual strain of the glass optical element along the optical axis thereof is equals to or greater than 2 nm.

In the Manufacturing method 1, it is further preferred that the glass optical element is a concave meniscus lens, biconcave lens, or plano-concave lens.

The present invention further relates to a method of manufacturing glass optical elements of desired refractive index n₃, by means of a press molding process comprising press molding a softened glass material in a pressing mold and cooling a molded element with a predetermined cooling rate, comprising:

obtaining a correlation between the cooling rates and refractive indexes as to a first glass composition by placing a glass material of the first glass composition under conditions essentially eliminating a thermal history and cooling the glass material with various cooling rates,

obtaining, by referring to the correlation, a reference refractive index A of the first glass composition corresponding to a specific cooling rate of a standard processing condition,

obtaining, by referring to the correlation, a refractive index B of the first glass composition corresponding to the predetermined cooling rate of the press molding process,

determining a second glass composition having a reference refractive index value which is obtained by adding the value resulted in subtracting B from A to C where C is the desired refractive index of the glass optical element, and

subjecting the glass material of the determined second glass composition to the press molding process.

This method is referred to hereinafter as “Manufacturing Method 2”.

The present invention still further relates to a method of determining a glass composition of a glass material for manufacturing glass optical elements of desired refractive index n3, by means of a press molding process comprising press molding a softened glass material in a pressing mold and cooling a molded element with a predetermined cooling rate, comprising:

preparing a interim optical element by means of the press molding process from a glass material of a first glass composition,

measuring a refractive index n₂ of the interim optical element,

obtaining the difference between a reference refractive index n1 of the first glass composition and the refractive index n₂,

preparing a second glass composition having reference refractive index substantially of the amount which is obtained by adding the difference to the refractive index n₃, and

determining the second glass composition as the glass composition for manufacturing glass optical elements,

wherein the reference refractive index is the refractive index of glass composition processed with a standard condition.

### BRIEF DESCRIPTION OF THE DRAWINGS

FIG. 1 is a descriptive chart showing the correlation between the refractive index of glass materials of prescribed composition and cooling rates.

### BEST MODE OF IMPLEMENTING THE INVENTION

The methods of manufacturing glass optical elements of the present invention are described in greater detail below.

The first method of manufacturing glass optical elements of the present invention (Manufacturing method 1) is a method of manufacturing a glass optical element having a desired refractive index by means of a press molding process comprising press molding of a glass material in a pressing mold and cooling of a resulting molded element.

In this method,

the refractive index n₂ of an interim optical element is measured, said interim optical element is obtained in the press molding process by using a glass material comprised of glass of prescribed composition;

the amount of difference between the reference refractive index n₁ and the refractive index n₂ of the interim optical element is calculated, said reference refractive index n₁ is a refractive index of glass of prescribed composition which has been processed under specific standard conditions (hereinafter, the refractive index of glass when processed under standard conditions is referred to as the “reference refractive index”);

glass which, when treated under the standard conditions, has a refractive index of a value obtained by adding the difference, or a value approximately equal to the difference, to the desired refractive index n₃ is prepared; and

a glass material comprising the glass that is prepared is employed to obtain a glass optical element having the desired refractive index n₃ by means of the press molding process.

Here, the term “the difference, or a value approximately equal to the difference” means a range of from 0.9 to 1.1 times the difference that is calculated. As stated further below, since the Abbé number (for example, ν_{d}) is preferably kept within a prescribed range in addition to the refractive index satisfies (for example, n_{d}) required range of value for the optical element that is manufactured, suitable adjustment is made within this range when conducting the above addition.

In other words, a glass material having a reference refractive index obtained by adding to n₃ a value of from (n₁−n₂)×0.9 to (n₁−n₂)×1.1 is employed.

n₁ is the reference refractive index of the glass of prescribed composition.

n₂ is the refractive index of the interim glass optical element obtained by the press molding process from the glass material of prescribed composition.

n₃ is the desired refractive index of the glass optical element.

Refractive indexes n₁, n₂, and n₃ mean refractive indexes at any fixed wavelength from among the measurement wavelengths of the F line, d line, and c line; the use of n_{d} based on the d line is preferred.

By way of example, in the first method of manufacturing glass optical elements of the present invention, a step of processing the glass of prescribed composition under standard conditions and obtaining refractive index n₁, may be conducted prior to the press molding process. When refractive indexes n₁ and n₂ are obtained in this manner just once prior to the press molding process, it is possible to continuously manufacture optical elements of glass having desired refractive index n₃ by means of a press molding process employing a glass material having the prescribed reference refractive index.

Accordingly, Manufacturing Method 1 of the present invention can be a method of manufacturing optical elements of glass having a desired refractive index n₃ by means of a press molding process comprising press molding a glass material using a pressing mold to, and by means of the use of a glass material having a reference refractive index (where the reference refractive index refers to the refractive index of glass processed under standard conditions) obtained by adding a value of from (n₁−n₂)×0.9 to (n₁−n₂)×1.1 to n₃ in the press molding process, comprising the steps of:

prior to conducting the press molding process, obtaining the refractive index n₁, of glass obtained by processing under standard conditions glass having a prescribed composition, and

obtaining the refractive index n₂ of a glass optical element obtained in the press molding process from a glass material having a composition identical to that of the prescribed composition.

As stated above, the refractive indexes measured at room temperature of glasses of identical composition vary with the thermal histories of the glasses reflecting their progression from glass melt to solid. Accordingly, in the present invention, to control the refractive index of the glass material based on composition, a glass of prescribed composition is processed under referenced conditions, that is, standard conditions, and the refractive index of the processed glass is employed. The refractive index of the glass obtained by processing under standard conditions is called the “reference refractive index”. The reference refractive index of the glass of prescribed composition is denoted as n₁. The reference refractive index denotes different values when the glass composition differs and different values for glasses that are of identical composition when processed under different standard conditions.

In the present Specification, the term “standard conditions” means maintaining the glass for a period and at a temperature essentially eliminating the past thermal history of the glass, and subsequently cooling the glass at a prescribed cooling rate. The thermal history of the glass is essentially eliminated by selecting a time and a temperature based on the glass composition. Specifically, the phrase “maintaining the glass for a period and at a temperature essentially eliminating the past thermal history of the glass” means maintaining the glass at a temperature greater than or equal to the glass transition temperature Tg until the temperature of all the glass becomes essentially uniform. From the perspective of measuring the refractive index with greater precision and efficiency, it is desirable to maintain the glass for a certain period of 15 minutes or more at a certain temperature of from Tg to Tg+30° C., preferably for a period of greater than or equal to 30 minutes and less than or equal to 5 hours.

The phrase “cooling the glass at a prescribed cooling rate” means cooling the glass under certain conditions at which the thermal history imparted to the glass is constant. Specifically, this desirably means cooling the glass at a gradual, essentially constant cooling rate that does not produce strain or variation in refractive index, and in a manner not affecting the measurement of the refractive index at room temperature. A cooling rate of less than or equal to 50° C./hr, for example, preferably 30° C./hr, is desirable, and cooling is conducted to at least 30° C. below the strain point, preferably 50° C. below the strain point.

That is, the processing under standard conditions referred to above desirably means maintaining the glass for a certain period of greater than or equal to 15 minutes at a certain temperature ranging from the glass transition temperature (Tg) to Tg+30, and then cooling the glass at a certain rate of less than or equal to 50° C./hr to 30° C. below the strain point.

In Manufacturing Method 1 of the present invention, the use of refractive index n₁ of glass having a prescribed composition that has been processed (maintained and cooled) under “standard conditions” permits objective determination and control of the value of the refractive index. Further, even when glass optical elements are prepared by press molding a glass material that has an identical composition but has been manufactured by different manufacturing methods, predetermination of refractive index n₁ yields optical elements of glass having a desired refractive index without having to measure the refractive index of each glass material.

The above-stated “standard conditions” of temperature, time, and cooling rate are not limited to the numeric ranges stated above. However, if uniform conditions are routinely used, variation of the reference refractive index occurs only with the glass composition, facilitating determination of the refractive index of the glass material. In the present invention, the term “refractive index” means a value measured at a room temperature of 23° C.±3° C.

In Manufacturing Method 1 of the present invention, processing (maintaining and cooling) under “standard conditions” is applied to “glass having a prescribed composition” and refractive index n₁ is obtained. Although the “prescribed composition” is not limited, it is desirably close to the final composition, including components essential to the composition of the targeted glass optical element, and is optimal for determining the final composition of the targeted glass material.

In Manufacturing Method 1 of the present invention, an interim glass optical element is manufactured by means of a press molding process using the actual method of manufacturing the glass optical element from glass having the same composition as the glass for which refractive index n₁ has been obtained, and the refractive index n₂ of the interim glass optical element thus obtained is measured.

As set forth above, the refractive indexes vary with thermal history even for glasses of identical composition. In methods of manufacturing glass optical elements, if the press molding temperature and cooling conditions employed in the press molding process vary, the refractive indexes of the glass optical elements obtained sometimes vary even when glass materials of identical composition are employed. Accordingly, in Manufacturing Method 1 of the present invention, the effect of the thermal history of the glass in the press molding process in the actual manufacturing method is determined by measuring refractive index n₂ of the glass of identical composition for which refractive index n₁ has been measured.

In the press molding process of Manufacturing Method 1 of the present invention, the press molding process refers not only to a step (referred to as “press molding”) of transferring the optically functional surface of a pressing mold by pressing in a pressing mold at a prescribed temperature a glass material having a viscosity permitting deformation by means of pressure in a pressing mold, but also to a series of steps of heating and softening the glass material and cooling following the above-described press molding. Here, the term “glass material” refers to glass materials employed in molding and includes preforms in the form of normal or flattened spheroid having the weight and shape of which have been made to approximate the molded one, blanks cut from glass blocks, as well as gobs generated by causing a glass melt to flow out of a pipe.

As will be set forth further below, the present invention can be applied irrespective of the thermal history following melting of the glass material. That is, any glass material can be employed, regardless of thermal history or the resulting refractive index. Glass materials obtained by rapidly quenching glass melt while preventing cracking may be employed, which is desirable from the viewpoint of increasing productivity. In that case, the refractive index of the glass material decreases in a corresponding manner, and although there are cases when the refractive index cannot be measured due to substantial strain, there is no impediment to achieving the effect of the present invention. In the course of preparing the glass material, a material having a glass melt outflow viscosity of from 10 to 1,000 poises that is cooled at a rate of greater than or equal to 300° C./min at least over the range from the softening point to 50° C. below the strain point is desirably employed. From the perspective of productivity, a material that is cooled at a rate of from 300 to 1,500° C./min is preferably employed, and a material that is cooled at a rate of from 400 to 1,000° C./min is more preferably employed.

Further, the effect of the present invention is advantageously achieved when the refractive index of the glass material is 500×10⁻⁵ or more lower than the reference refractive index of that composition.

For example, in the press molding process, the glass material, assuming that the viscosity thereof is from 10^{5.5} to 10⁹ poises, is suitably press molded in a pressing mold preheated to a temperature at which the glass material being press molded exhibits a viscosity of from 10⁷ to 10¹² poises. Keeping the temperature of the glass material within the above-stated range essentially eliminates the thermal history of the glass material within a short period.

Following press molding, simultaneously with the start of press molding, or during the course of press molding, the glass material that has been molded or is being molded is cooled. The cooling rate in the press molding process can be determined based on the following. To increase productivity, the greater the cooling rate the better. However, sudden cooling causes a great deal of strain to remain in the glass optical element, impeding optical performance. The amount of residual strain permitted varies with the application and precision of the optical product being employed. Accordingly, it suffices to determine the cooling rate with the range of strain permitted in the optical product being employed. Cooling is suitably conducted at, for example, a rate of from 10 to 250° C./min, preferably from 30 to 100° C./min, to a temperature less than or equal to Tg.

If the shape and size of glass elements being manufactured vary when employing glass materials of identical composition, the essential cooling rate of the press molded product sometimes varies and the refractive index of the glass optical elements obtained sometimes differ even when identical press molding and cooling are employed. Thus, when strict control is required, refractive indexes n₁, n₂, and n₃ are desirably measured for glass identical in shape and size to the targeted glass optical element. Further, to prevent slight variation in the cooling rate due to differences in size and shape, the cooling method can be minutely adjusted to control the substantial cooling rate of the glass optical elements and remain within the permitted refractive index range. The effect on the refractive index of slight differences in cooling rate in the press molding process set forth above is relatively small.

In Manufacturing Method 1 of the present invention, denoting the refractive index that is to be exhibited by the glass optical element that is the final product as n₃, a glass material having a reference refractive index obtained by adding a value of from (n₁−n₂)×0.9 to (n₁n₂)×1.1 to n₃ is employed. That is, a glass material for which the refractive index exhibited by the glass material processed under standard conditions falls within the above-stated range is employed. The glass material having a reference refractive index obtained by adding a value of from (n₁−n₂)×0.9 to (n₁−n₂)×1.1 to n₃ can be prepared, for example, by adjusting the glass composition.

More specifically, a glass material having a reference refractive index falling within the above-stated range can be prepared, either by increasing or decreasing the amount by which the refractive index is adjusted for a prescribed composition, or by blending in a suitable proportion of vitreous material having a reference refractive index approaching the reference refractive index of the glass material having a reference refractive index within the above-stated range. The refractive index is desirably adjusted primarily by adjusting the mass ratio of B₂O₃, SiO₂, and BaO in barium borosilicate glass. Other known refractive index adjusting components may also be employed. Conventionally employed methods of adjusting the composition of the glass material may be employed to microadjust n_{d}. Conventionally employed methods may also be suitably employed to microadjust ν_{d}, described further below.

The present invention includes the method of determining the composition of the above-described glass material employed in the method of manufacturing glass optical elements of desired refractive index by means of a press molding process comprising the press molding of a glass material in a pressing mold.

This method is characterized in that the refractive index n₁ of a glass of prescribed composition that has been processed under standard conditions and the refractive index n₂ of an interim glass optical element obtained by means of the above-described press molding process from a glass material having the same composition as the above-described prescribed composition are measured, and a glass composition having a reference refractive index being a value obtained by adding from (n₁−n₂)×0.9 to (n₁−n₂)×1.1 to the desired refractive index n₃ of the glass optical element is adopted as the glass composition of the glass material.

The standard conditions, reference refractive index, refractive index n₁, refractive index n₂, adjustment of the glass composition of the glass material, and press molding process are defined as above in Manufacturing Method 1 of the present invention.

In Manufacturing Method 1 of the present invention and in the method of determining the glass composition of the glass material, the glass employed as the glass material is not specifically limited, it being possible to effectively employ various optical glasses in the present invention. One example is barium borosilicate glass. Preferred compositions of barium borosilicate glass are, for example, optical glasses characterized by glass components of:

30 to 55 weight percent of SiO₂,

5 to 30 weight percent of B₂O₃,

where the total content of SiO₂ and B₂O₃ is from 56 to 70 weight percent and the weight ratio of SiO₂/B₂O₃ is from 1.3 to 12.0,

7 to 12 weight percent of Li₂O (excluding 7 weight percent)

0 to 5 weight percent of Na₂O,

0 to 5 weight percent of K₂O,

where the total content of Li₂O, Na₂O, and K₂O is from 7 to 12 weight percent (excluding 7 weight percent),

10 to 30 weight percent of BaO,

0 to 10 weight percent of MgO,

0 to 20 weight percent of CaO,

0 to 20 weight percent of SrO,

0 to 20 weight percent of ZnO,

where the glass contains from 10 to 30 weight percent of BaO, MgO, CaO, SrO, and ZnO, and of these glass components, the total content of SiO₂, B₂O₃, Li₂O, and BaO is greater than or equal to 72 weight percent and TeO₂ is not contained.

The above-listed glasses further comprising:

1 to 7.5 weight percent of Al₂O₃,

0 to 3 weight percent of P₂O₅,

0 to 15 weight percent of La₂O₃,

0 to 5 weight percent of Y₂O₃,

0 to 5 weight percent of Gd₂O₃,

0 to 3 weight percent of TiO₂,

0 to 3 weight percent of Nb₂O₅,

0 to 5 weight percent of ZrO₂, and

0 to 5 weight of PbO are also suitably employed.

Additional preferred glass types are lanthanum series optical glasses, examples of which are glasses comprising, as weight percentages, 25 to 42 percent B₂O₃, 14 to 30 percent La₂O₃, 2 to 13 percent Y₂O₃, 2 to 20 percent SiO₂, more than 2 percent and not more than 9 percent Li₂O, 0.5 to 20 percent CaO, 2 to 20 percent ZnO, 0 to 8 percent Gd₂O₃, 0 to 8 percent ZrO₂, and 0.5 to 12 percent Gd₂O₃+ZrO₂, with these components comprising not less than 90 percent of the total content. In some cases, these glasses may also comprise 0 to 5 percent Na₂O, 0 to 5 percent K₂O, 0 to 5 percent MgO, 0 to 5 percent SrO, 0 to 10 percent BaO, 0 to 5 percent Ta₂O₅, 0 to 5 percent Al₂O₃, 0 to 5 percent Yb₂O₃, 0 to 5 percent Nb₂O₅, 0 to 2 percent As₂O₃, and 0 to 2 percent Sb₂O₃.

In Manufacturing Method 1 of the present invention, a glass material having a reference refractive index obtained by adding from (n₁−n₂)×0.9 to (n₁−n₂)×1.1 to n₃ is particularly desirable.

In Manufacturing Method 1 of the present invention, the reference refractive indexes can sometimes be measured in advance for various glasses of differing composition to facilitate selection of the glass material. Further, glass with a reference refractive index of n₃±0.01 can be selected as the glass of prescribed composition to obtain an optical element of desired refractive index with good precision because the properties thereof are close to those of the glass material employed to obtain optical elements of desired refractive index.

Further, desired refractive index n₃ of the glass optical element is desirably equal to reference refractive index n₁ of the glass of prescribed composition.

In the method of manufacturing glass optical elements, it is important that not only the refractive index, but also the Abbé number be within a desired range for optical design. Accordingly, in Manufacturing Method 1 of the present invention, in the course of determining the composition to obtain a desired optical element, in addition to the refractive index, the Abbé number also desirably falls within the prescribed range stated below. That is, when the glass material employed in the press molding process has a reference Abbé number obtained by adding a value of from (ν₁−ν₂)×0.9 to (ν₁−ν₂)×1.1 to ν₃, it is possible to obtain an optical element having a desired Abbé number ν₃.

The reference Abbé number is the Abbé number of glass that has been processed under standard conditions.

ν₁ is the reference Abbé number of glass having a prescribed composition.

ν₂ is the Abbé number of the interim glass optical element obtained by the above-described press molding process from the glass material of the same composition as the prescribed composition.

And ν₃ is the desired Abbé number of the glass optical element.

The above-stated “processing under standard conditions”, “glass of prescribed composition”, and “press molding process” are identical to those described for the refractive index. The glass material having a reference Abbé number within the above-stated range can be prepared by the same method as for the refractive index. For example, the above-described glass of prescribed composition can be prepared by increasing or decreasing the amount of refractive index adjusting component contained in the prescribed composition. The glass material desirably has a reference Abbé number obtained by adding a value of from (ν₁−ν₂)×0.95 to (ν₁−ν₂)×1.05 to ν₃.

Abbé numbers based on the d line that are given by the equation below are suitably employed for Abbé numbers ν₁, ν₂, and ν₃. However, Abbé numbers based on other wavelengths present no essential problems.

$${v}_{d} = \frac{{n}_{d} - 1}{{n}_{F} - {n}_{c}}$$

Refractive index n_{d} and Abbé number ν_{d} are generally referred to as optical constants and are employed as indicators in optical design.

In Manufacturing Method 1 of the present invention, as stated above, glass having a reference refractive index falling within a range of n₃±0.01 is desirably selected as the glass having a prescribed composition. Similarly, glass having a reference Abbé number falling within a range of ν₃±1 is desirably selected as the glass having a prescribed composition. This is because an optical element of specified refractive index and an Abbé number can be obtained with high precision due to properties similar to those of the glass material employed to obtain an optical element having the desired refractive index and Abbé number.

As a preferred mode of the present invention, it is possible to manufacture an optical element by maintaining a gob of glass melt of prescribed composition at a temperature of Tg+30° C. for 2 hours, cooling the gob at a cooling rate of 30° C./hr to a temperature 50° C. or more below the strain point, subsequently determining the difference between the reference refractive index (n₁) measured at room temperature and the refractive index (n₂) at room temperature of the interim optical element obtained by press molding, adding the difference (n₁−n₂)×1.0 to the desired refractive index (n₃) of the optical element, employing the refractive index thus obtained as the reference refractive index, and employing a glass material of a composition having the reference refractive index in an identical press molding process. Here, the glass material of prescribed composition desirably has a refractive index falling within the range of n₃±0.01 and an Abbé number falling within the range of ν₃±1.

Manufacturing Method 2 of the present invention is a method of manufacturing optical elements of glass having a specified refractive index by subjecting a glass material to a press molding process, in the same manner as Manufacturing Method 1 of the present invention. However, in Manufacturing Method 2, the correlation between the cooling rate and refractive index following cooling when a glass material of prescribed composition has been cooled from a certain heated state is exploited.

First, glass having a prescribed composition is placed under conditions adequate to substantially eliminate the thermal history thereof. It is then cooled at a number of different cooling rates, the individual refractive indexes of the glass are measured following cooling, and the correlation between the cooling rate and the refractive index is obtained. Except for varying the cooling rate, this processing is identical to the processing under standard conditions described for Manufacturing Method 1 of the present invention.

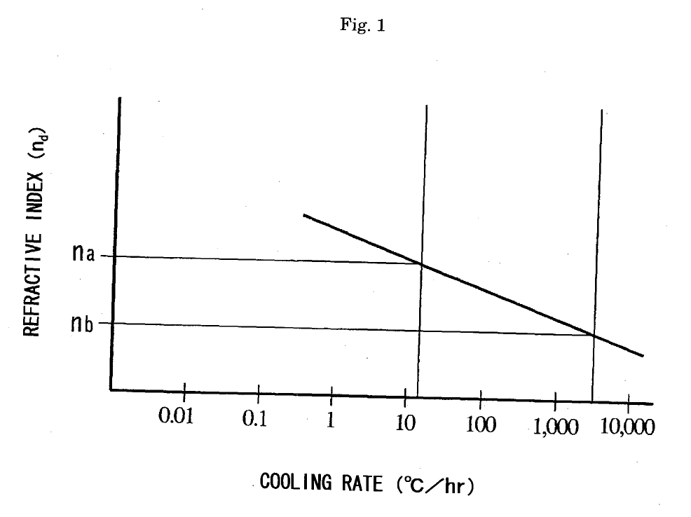

When the glass composition is constant and the glass is maintained under conditions (temperature and time) adequate to erase the thermal history, the refractive index exhibited by the glass following cooling depends solely on the cooling rate. Specifically, the correlation between the log (x-axis) of the cooling rate and the refractive index (y-axis) exhibits a linear relation such as that shown in FIG. 1. The slope of this line is determined by the glass composition. However, when this correlation is obtained in advance for glass having a prescribed composition, the refractive index of an optical element of glass obtained by press molding and cooling a glass material of that composition can be calculated by deciding the cooling rate in the pressing molding process.

Accordingly, in Manufacturing Method 2 of the present invention, the refractive index (refractive index A) when glass is processed under the standard conditions is calculated from the correlation based on the cooling rate in the standard conditions for glass having the same composition as the glass for which the relation between the cooling rate and refractive index has been measured in advance. Here, the term “standard conditions” is identical in meaning to the processing in Manufacturing Method 1 of the present invention.

Next, the cooling rate in the press molding process is determined, and the refractive index (refractive index B) of glass corresponding to that cooling rate is calculated from the above correlation, the glass has identical composition to the glass for which the relation between cooling rate and refractive index has been measured in advance. This cooling rate can be employed as the rate within the range of strain permitted in the glass optical element.

When there is a difference between the cooling rate in the processing under standard conditions and the cooling rate determined as set forth above, the difference in the refractive indexes is calculated by subtracting refractive index B from refractive index A. This difference in refractive indexes is then added to desired refractive index C, and the composition of the glass is determined so that the glass indicates the refractive index obtained when processing is conducted under the standard conditions. Desired refractive index C is desirably identical to refractive index A.

When the glass is “processed under standard conditions”, refractive index A is calculated as nₐ in FIG. 1 if the cooling rate in “processing under standard conditions” is 30° C./hr, for example. Further, refractive index B corresponding to the cooling rate employed in the actual manufacturing method is calculated as refractive index n_{b} if the cooling rate is set to 4,800° C./hr, for example.

The composition of the glass is determined so that the glass indicates the refractive index obtained by adding the difference between refractive index A and refractive index B (nₐ−n_{b}) to the desired refractive index C, or n_{c}, when “processing under standard conditions” has been conducted.

Glass of the composition determined in this manner is employed as the glass material.

The glass material can be obtained by formulating and melting glass starting materials, and glass having the above-described determined composition can be obtained by adjusting the composition of the glass starting materials.

The refractive indexes of the above-described glass material and glass starting materials can be adjusted by adjusting the glass composition in response to the above-described difference in refractive index. The same means as described for Manufacturing Method 1 of the present invention can be employed to adjust the glass composition.

According to Manufacturing Method 2 of the present invention, a glass optical element of desired refractive index can be obtained by a prescribed press molding process without having to actually measure the refractive index of the optical element obtained through the press molding process from a glass material of prescribed composition. That is, in Manufacturing Method 2 of the present invention, the refractive index of the glass optical element obtained by press molding can be adjusted to a desired value by a simple means. Thus, it is possible to eliminate or shorten the annealing step, depending on the permitted range of strain required in the optical product. In this manufacturing method, the cooling in the press molding process used to obtain an optical element is desirably conducted to a temperature 30° C. below the deformation point at the cooling rate determined as set forth above.

In Manufacturing Methods 1 and 2 of the present invention, aiming at the fact that there are optical systems in which no practical impediments are presented even when strain remains in the direction of the optical axis of the glass optical element that is manufactured if the strain is within a certain range, productivity can be raised by eliminating or shortening annealing, after-processing, or increasing the cooling rate in the press molding process. Examples of such optical systems are optical systems employed in video cameras and digital cameras. The residual strain in the direction of the optical axis is desirably greater than or equal to 2 nm and less than or equal to 60 nm, more preferably greater than or equal to 2 nm and less than or equal to 40 nm.

That is, the present invention includes the method of manufacturing glass optical elements having a desired refractive index in which retardation by strain is from 2 to 60 nm by means of a press molding process comprising the press molding of a glass material in a pressing mold.

The shape of the optical element obtained by the manufacturing methods of the present invention is not specifically limited so long as strain is not excessive. The methods of the present invention can be suitably applied to optical elements having either concave or convex surfaces.

For example, the methods of the present invention are suitably applied to biconvex lenses, convex meniscus lenses, and plano-convex lenses having retardation by residual strains of from 2 to 60 nm, preferably from 2 to 40 nm, with convex meniscus lenses being particularly preferred.

Conventionally, when an annealing step is conducted following press molding, problems are encountered in the form of a tendency toward deterioration of shape precision in concave meniscus lenses, biconcave lenses, and plano-concave lenses. The present inventors discovered that in lenses of these shapes, particularly in concave meniscus lenses, residual strain following molding is extremely low, particularly along the optical axis. According to the present invention, it is possible to eliminate the annealing step and efficiently produce concave meniscus lenses, biconcave lenses, and plano-concave lenses of desired optical constants and low strain.

One example is an optical element in the form of a concave meniscus lens manufactured in a press molding process in which the glass is cooled to at least Tg at a cooling rate of from 10 to 250° C./min with essentially no subsequent annealing step, and the residual strain along the optical axis is from 2 to 8 nm, preferably 2 to 5 nm. In addition to use in the above-stated optical systems, this lens can be employed in the optical systems of cameras for silver salt film, particularly single-eye reflex cameras.

The present invention also includes optical elements obtained by the manufacturing methods of the above-described invention. These optical elements desirably have effective optical diameters of less than or equal to 20 mm, preferably less than or equal to 15 mm.

### EXAMPLES

The present invention will be described below in greater detail through suitable Examples.

In the Examples set forth below, refractive index n_{d} and Abbé number ν_{d} are employed as optical constants.

### Reference Example 1

A glass lens was manufactured from barium borosilicate optical glass (basic composition: 37.8 weight percent SiO₂, 24.0 weight percent B₂O₃, 5.3 weight percent Al₂O₃, 8.5 weight percent Li₂O, 5.0 weight percent CaO, 16.1 weight percent BaO, 3.3 weight percent La₂O₃, 0.5 weight percent As₂O₃, 0.2 weight percent Sb₂O₃, Tg: 500° C.).

The above-denoted barium borosilicate glass was melted, made to flow from an outflow pipe, cut, and cooled (quenched in air) to obtain oblate spheroid preforms (a glass material for press molding). The preforms had high strain precluding measurement of their refractive indexes, but were presumed to have quite low values. They were maintained for 2 hr at Tg+30° C. and cooled at a cooling rate of 30° C./hr to a temperature 50° C. below the strain point. The refractive index thereof was measured at room temperature (n_{d}1.58900, ν_{d}61.30). These were referred to as the reference refractive index and reference Abbé number.

The quenched preforms were subjected to a press molding process. A known pressing mold for molded glass lenses comprising an upper mold and lower mold made of silicon carbide the outer surface of which had been coated with a carbon film was employed to mold glass optical elements. That is, the above-described preform was placed in the mold, the preform and the pressing mold were heated in a non-oxidizing atmosphere to a temperature at which the glass viscosity reached 10^{7.6} poises, the preform was pressed for 50 sec at that temperature at a pressure of 98 MPa (100 kg/cm²), the pressed glass was cooled to a temperature 30° C. below the strain point at a cooling rate of 80° C./min in the pressing mold, and the lens obtained was removed. The lens was a convex meniscus lens with a pressed diameter of 14 mm and a center thickness of 3 mm. Measurement revealed maximum retardation by strain along the optical axis of 20 nm. Refractive index n_{d} was 1.58600 and Abbé number ν_{d} was 61.25.

Next, a quenched preform that had been first maintained for 2 hr at Tg+30° C. and then cooled to 50° C. below the strain point at a cooling rate of 30° C./hr (maintaining the preform for 2 hr at Tg+30 and cooling to a temperature 50° C. below the strain point at a cooling rate of 30° C./hr correspond to “processing under standard conditions”) was subjected to a press molding process in which it was press molded and cooled under conditions identical to those set forth above. The lens obtained had a maximum retardation by strain along the optical axis of 20 nm, an n_{d} of 1.58600, and a ν_{d} of 61.25. It thus had precisely the same optical constants as when the quenched preform was press molded.

This shows that increasing the temperature in the press molding process to a level where the glass viscosity reaches 10^{7.6} poises eliminates the effect of the thermal history preceding the press molding process so that glass of identical composition develops the same refractive index (and Abbé number) following a certain press molding process.

### Example 1

The refractive index n_{d} of 1.58900 and the Abbé number ν_{d} of 61.30 obtained in Reference Example 1 with respect to the preform that was maintained for 2 hrs at Tg+30° C. and cooled at a cooling rate of 30° C./hr (processing under standard conditions) are the reference refractive index and reference Abbé number and are denoted as n₁ and ν₁, respectively.

Further, in Reference Example 1, the glass of the above-described composition press molded under the conditions as described exhibits n_{d} of 1.58600 and ν_{d} of 61.25. That is, n₂ was an n_{d} of 1.58600 and ν₂ was a ν_{d} of 61.25.

That is, n₁−n₂ was 300×10⁻⁵ and ν₁−ν₂ was 0.05.

Further, an n_{d} of 1.58900 and a ν_{d} of 61.30 were selected as the desired values (n₃ and ν₃) of lens design and lenses were molded.

Accordingly, a glass material the reference refractive index of which was 300×10⁻⁵ higher than that of n₃ was prepared as a preform (glass material) so that the glass optical element would have the desired refractive index n₃ following the press molding process. That is, a preform (glass material) the reference refractive index of which as (n₁−n₂) +n₃=n_{d}1.59200 was prepared by changing the glass composition. That is, to prepare a refractive index corresponding to a refractive index difference of (n₁−n₂), BaO was increased 1.0 weight percent, SiO₂ was decreased 0.5 weight percent, B₂O₃ was decreased 0.4 weight percent, and Al₂O₃ was decreased 0.1 weight percent. The glass of this composition was measured following processing under the above-described conditions, revealing a reference refractive index n_{d} of 1.59200 and a reference Abbé number ν_{d} of 61.35.

The glass of this composition was melted, preforms were prepared, and glass optical elements were molded in a press molding process under conditions identical to those in Reference Example 1. The resulting glass optical elements had a refractive index n_{d} of 1.58900 and an Abbé number ν_{d} of 61.30.

Table 1 below shows the relation between the various refractive indexes and Table 2 shows the relation between the various Abbé numbers.

TABLE 1

| | n_{d} |
|---|---|
| n₃ | 1.58900 |
| n₁ | 1.58900 |
| n₂ | 1.58600 |
| n₁ − n₂ | 300 × 10⁻⁵ |
| (n₁ − n₂) + n₃ | 1.59200 |
| refractive index of glass optical element | 1.58900 |

TABLE 2

| | ν_{d} |
|---|---|
| ν₃ | 61.30 |
| ν₁ | 61.30 |
| ν₂ | 61.25 |
| ν₁ − ν₂ | 0.05 |
| (ν₁ − ν₂) + ν₃ | 61.35 |
| Abbé number of glass optical element | 61.30 |

### Example 2

A lens with an n_{d} of 1.58900 and a ν_{d} of 61.30 was obtained by a press molding process in Example 1. By contrast, when a preform of identical glass composition was press molded at cooling rate in the press molding process that had been changed from 80° C./min to 120° C./min, the refractive index dropped, n_{d} became 1.58815, ν_{d} became 61.28, and there was deviation from the desired optical constant (refractive index and Abbé number) specifications. That is, n₂ was an n_{d} of 1.58815, ν₂ was a ν_{d} of 61.28, n₁−n₂ was 385×10⁻⁵, and ν₁−ν₂ was 0.02.

Accordingly, a glass composition was changed from the original base composition by increasing BaO 1.2 weight percent and decreasing SiO₂ 0.6 weight percent, B₂O₃ 0.48 weight percent, and Al₂O₃ 0.12 weight percent so that a reference refractive index n_{d} of 1.59285 and a ν_{d} of 61.37 will be achieved. Glass of that composition was melted and a preform was prepared. This preform was subjected to a press molding process, yielding a lens with the desired optical constants of an n_{d} of 1.58900 and a ν_{d} of 61.30.

Table 3 below shows the relation between the individual refractive indexes and Table 4 below shows the relation between the individual Abbé numbers.

TABLE 3

| | n_{d} |
|---|---|
| n₃ | 1.58900 |
| n₁ | 1.59200 |
| n₂ | 1.58815 |
| n₁ − n₂ | 385 × 10⁻⁵ |
| (n₁ − n₂) + n₃ | 1.59285 |
| refractive index of glass optical element | 1.58900 |

TABLE 4

| | ν_{d} |
|---|---|
| ν₃ | 61.30 |
| ν₁ | 61.35 |
| ν₂ | 61.28 |
| ν₁ − ν₂ | 0.07 |
| (ν₁ − ν₂) + ν₃ | 61.37 |
| Abbé number of glass optical element | 61.30 |

Example 2 resulted in a shortened cycle time and improved productivity due to the rapid cooling rate. Retardation by strain Distortion was 40 nm, which was within the range permitted for this optical design. Surface precision was also good. Optical coefficient adjustment by changes in the quantities of SiO₂, B₂O₃, Al₂O₃, and BaO resulted in almost no change in the glass transition temperature and sag point, nor was there any decrease in the chemical durability of the glass.

### Example 3

A lanthanum series optical glass (Tg: 530° C., Ts: 570° C.) with a basic composition of 7.0 weight percent SiO₂, 34.0 weight percent B₂O₃, 3.5 weight percent Li₂O, 7.5 weight percent CaO, 9.0 weight percent ZnO, 24.0 weight percent La₂O₃, 8.0 weight percent Y₂O₃, 3.0 weight percent Gd₂O₃, and 4.0 weight percent ZrO₂ was melted, made to flow from an outflow pipe, cut, and cooled (quenched in air) to obtain oblate spheroid preforms. The preforms had high strain precluding measurement of their refractive indexes, but were presumed to have values considerably lower than the reference refractive index. They were maintained for 2 hrs at Tg+30° C. and cooled at a cooling rate of 30° C./hr to a temperature 50° C. below the strain temperature. The refractive index thereof was measured at room temperature. The refractive index n_{d} was 1.69750 and the Abbé number ν_{d} was 53.60. This was adopted as the reference refractive index.

The quenched preforms were subjected to a press molding process. The mold material was identical to that in Example 1, but here concave meniscus lenses with a pressed diameter of 15 mm and a center thickness of 1.1 mm were molded. The preforms were floated on a gas current in a floating dish, heated, and softened to a glass viscosity of 10^{6.7} poises, transferred onto the lower mold of a pressing mold that had been preheated to a temperature corresponding to a glass viscosity of 10^{8.7} poises, and immediately pressed for 20 sec at a pressure of 98 MPa (100 kg/cm²). The pressure was then reduced, and while still in their pressed state, the lenses were cooled to below the Tg at a cooling rate of 60° C./min. The lenses were removed, the lenses alone were cooled, and the lenses were collected. Measurement revealed retardation by strain along the optical axis of these lenses to be 5 nm. The refractive index n_{d} was 1.69350 and the Abbé number ν_{d} was 53.40.

n₂ was an n_{d} of 1.69350, ν₂ was a ν_{d} of 53.40, n₁−n₂ was 400×10⁻⁵, and ν₁−ν₂ was 0.20.

A refractive index of n_{d} 1.69750 and an Abbé number of ν_{d} 53.60 were made the desired optical constants in an optical design. The glass composition was adjusted as follows to yield these optical constants following pressing: in the base composition, SiO₂ was reduced 1.0 weight percent, Li₂O 0.5 weight percent, CaO 2.5 weight percent, ZnO 1.5 weight percent, and ZrO₂ 0.5 weight percent, and B₂O₃ was increased 1.5 weight percent, La₂O₃ 3.5 weight percent, and Gd₂O₃ 1.0 weight percent. This glass (Tg: 540° C., Ts: 580° C.) was maintained for 2 hours at Tg+30° C. and cooled to 50° C. below the strain point at a cooling rate of 30° C./hr. Measurement at room temperature revealed a refractive index n_{d} of 1.70150 and an Abbé number ν_{d} of 53.80.

This glass was melted, made to flow from an outflow pipe, cut, and cooled (quenched in air) to obtain oblate spheroid preforms. The quenched preforms were subjected to a press molding process. That is, the same mold materials were employed as in Example 1 and concave meniscus lenses with a pressed diameter of 15 mm and a center thickness of 1.1 mm were molded. As before, the preforms were floated on a gas current in a floating dish, heated, and softened to a glass viscosity of 10^{6.7} poises, transferred onto the lower mold of a pressing mold that had been preheated to a temperature corresponding to a glass viscosity of 10^{8.7} poises, and immediately pressed for 20 sec at a pressure of 98 MPa (100 kg/cm²). The pressure was then reduced, and while still in their pressed state, the lenses were cooled to below the Tg at a cooling rate of 60° C./min. The lenses were removed, the lenses alone were cooled, and the lenses were collected. Measurement revealed retardation by strain along the optical axis of these lenses to be 5 nm. The refractive index n_{d} was 1.69750 and the Abbé number ν_{d} was 53.60. They were thus lenses having the desired optical constants.

Table 5 below shows the relations of the various refractive indexes above and Table 6 the relations of the various Abbé numbers above.

TABLE 5

| | n_{d} |
|---|---|
| n₃ | 1.69750 |
| n₁ | 1.69750 |
| n₂ | 1.69350 |
| n₁ − n₂ | 400 × 10⁻⁵ |
| (n₁ − n₂) + n₃ | 1.70150 |
| refractive index of glass optical element | 1.69750 |

TABLE 6

| | ν_{d} |
|---|---|
| ν₃ | 53.60 |
| ν₁ | 53.60 |
| ν₂ | 53.40 |
| ν₁ − ν₂ | 0.20 |
| (ν₁ − ν₂) + ν₃ | 53.80 |
| Abbé number of glass optical element | 53.60 |

In Manufacturing Method 1 of the present invention, when obtaining glass optical elements of desired refractive index, it is unnecessary to actually measure the refractive index prior to the press molding process. It is always sufficient to determine the relation between the reference refractive index (refractive index of glass that has been processed under standard conditions) to the specified refractive index (the refractive index of an interim glass optical element obtained under the same conditions as in the actual press molding process).

In the press molding process of the present invention, the glass material is subjected to a temperature that essentially eliminates the thermal history of the glass material, thereby making it possible to obtain glass optical elements of desired refractive index in a manner independent of the refractive index of the glass material, without requiring measurement, and according to certain rules.

Further, in the manufacturing method of the present invention, irrespective of the thermal history subsequent to melting of the specified glass material employed in the press molding process, that is, regardless of whether the preform has been obtained by flowing and quenching (even if a quenched material the refractive index cannot be measured) or has been obtained by cutting from a block, so long as the glass composition is constant, glass optical elements of desired refractive index can be precisely obtained in a certain press molding process according to a consistent rule.

Further, according to the level of strain permitted in the optical product, while the annealing process can be eliminated or shortened, optical elements of desired refractive index can be precisely manufactured. This is particularly advantageous for optical elements having shapes the precision of which tends to be deteriorated by annealing.

Further, since the refractive index of the glass optical element is constantly determined according to a fixed standard, control is facilitated. That is, determining the relation among the reference refractive index of the glass material, the refractive index of the glass optical element obtained in the press molding process, and the desired refractive index of the glass optical element in advance makes it possible to obtain an optical element of desired refractive index irrespective of the thermal history of the glass material employed, without need to actually measure the amount of change in the refractive index during the press molding.

The present disclosure relates to the subject matter contained in Japanese Patent Application No. 2002-31244 filed on Feb. 7, 2002 which is expressly incorporated herein by reference in its entirety.

What is claimed is:

1. A method of manufacturing glass optical elements of desired refractive index n₃, by means of a press molding process comprising press molding a softened glass material in a pressing mold and cooling a molded element with a predetermined cooling rate, comprising:
preparing a interim optical element by means of the press molding process from a glass material of a first glass composition,
measuring a refractive index n₂ of the interim optical element,
obtaining the difference between a reference refractive index n₁ of the first glass composition and the refractive index n₂,
preparing a second glass composition having reference refractive index substantially of the value which is obtained by adding the difference to the refractive index n₃, and
preparing an optical element by means of the press molding process from a glass material of the second glass composition,
wherein the reference refractive index is the refractive index of glass composition processed with a standard condition.

2. The method of claim 1 further comprising processing the glass material of the first glass composition with the standard condition for obtaining the reference refractive index n₁ in advance of the press molding process.

3. The method of claim 2 wherein the second glass composition is prepared by adjusting the composition of the first glass composition.

4. The method of claim 1 wherein the glass material of the second glass composition has a reference Abbé number obtained by adding the value in the range from (ν₁−ν₂)×0.9 to (ν₁−ν₂)×1.1 to ν₃, when a reference Abbé number of the first glass composition is denoted as ν₁, an Abbé number of the interim optical element is denoted as ν₂, and an Abbé number of the desired optical element is denoted as ν₃, and the reference Abbé number is the Abbé number of glass composition processed with the standard condition.

5. The method of claim 1 wherein the first glass composition has the reference refractive index n1 falling within a range of n₃±0.01 and a reference Abbé number falling within a range of ν₃±1.

6. The method of claim 1 where the desired refractive index n₃ of the glass optical element equals to the reference refractive index n1 of the first glass composition.

7. The method of claim 1 wherein the glass material of the first or the second glass composition is prepared by cooling the glass melt at a cooling rate of from 300° C. to 1,500° C./minutes at least over a range of from a softening point to a strain point minus 50° C.

8. The method of claim 1 wherein a refractive index of the glass material of the second glass composition is at least 500×10⁻⁵ lower than the reference refractive index of the same glass composition.

9. The method of claim 1 wherein retardation by residual strain of the glass optical element along the optical axis thereof is equal to or less than 60 nm.

10. The method of claim 9 wherein the retardation by residual strain of the glass optical element along the optical axis thereof is equals to or greater than 2 nm.

11. The method of claim 1 wherein the glass optical element is a concave meniscus lens, biconcave lens, or plano-concave lens.

12. A method of manufacturing glass optical elements of desired refractive index n3, by means of a press molding process comprising press molding a softened glass material in a pressing mold and cooling a molded element with a predetermined cooling rate, comprising:
obtaining a correlation between the cooling rates and refractive indexes as to a first glass composition by placing a glass material of the first glass composition under conditions essentially eliminating a thermal history and cooling the glass material with various cooling rates,
obtaining, by referring to the correlation, a reference refractive index A of the first glass composition corresponding to a specific cooling rate of a standard processing condition,
obtaining, by referring to the correlation, a refractive index B of the first glass composition corresponding to the predetermined cooling rate of the press molding process,
determining a second glass composition having a reference refractive index value which is obtained by adding the value resulted in subtracting B from A to C where C is the desired refractive index of the glass optical element, and
subjecting the glass material of the determined second glass composition to the press molding process.

13. A method of determining a glass composition of a glass material for manufacturing glass optical elements of desired refractive index n₃, by means of a press molding process comprising press molding a softened glass material in a pressing mold and cooling a molded element with a predetermined cooling rate, comprising:
preparing a interim optical element by means of the press molding process from a glass material of a first glass composition,
measuring a refractive index n₂ of the interim optical element,
obtaining the difference between a reference refractive index n1 of the first glass composition and the refractive index n₂,
preparing a second glass composition having reference refractive index substantially of the amount which is obtained by adding the difference to the refractive index n₃, and
determining the second glass composition as the glass composition for manufacturing glass optical elements,
wherein the reference refractive index is the refractive index of glass composition processed with a standard condition.
